(19) United States
(12) Patent Application Publication
(10) Pub. No.: US 2020/0396497 A1
(43) Pub. Date: Dec. 17, 2020

(54) RECOMMENDED CONTENT DISPLAY METHOD AND APPARATUS, TERMINAL, AND COMPUTER-READABLE STORAGE MEDIUM

(71) Applicant: TENCENT TECHNOLOGY (SHENZHEN) COMPANY LIMITED, Shenzhen (CN)

(72) Inventors: Song LIU, Shenzhen (CN); Huaizheng WANG, Shenzhen (CN); Binbin ZHAO, Shenzhen (CN)

(73) Assignee: TENCENT TECHNOLOGY (SHENZHEN) COMPANY LIMITED, Shenzhen (CN)

(21) Appl. No.: 17/004,164

(22) Filed: Aug. 27, 2020

Related U.S. Application Data
(63) Continuation of application No. PCT/CN2019/088153, filed on May 23, 2019.

(30) Foreign Application Priority Data
Jul. 20, 2018 (CN) 201810804445.3

(51) Int. Cl. H04N 21/431; H04N 21/482; H04N 21/442

(52) U.S. Cl. CPC H04N 21/4316; H04N 21/442; H04N 21/4826

(57) ABSTRACT

This application discloses a recommended content display method and apparatus, a terminal, and a storage medium, and is generally related to the field of content recommendation. The method can include playing a target video in a video play region of a video player, reducing a size of the video play region when the target video is played to closing credits, and displaying, in the video player, the video play region whose size is reduced and recommended content. The video play region whose size is reduced can be used for continuing to play the target video.

### RELATED APPLICATION

This application is a continuation of International Application No. PCT/CN2019/088153, filed on May 23, 2019, which claims priority to Chinese Patent Application No. 201810804445.3, entitled “RECOMMENDED CONTENT DISPLAY METHOD AND APPARATUS, TERMINAL, AND COMPUTER-READABLE STORAGE MEDIUM” filed on Jul. 20, 2018. The entire disclosures of the prior applications are hereby incorporated by reference in their entirety.

### FIELD OF THE TECHNOLOGY

Embodiments of this application relate to the field of content recommendation, including to a recommended content display method and apparatus, a terminal, and a computer-readable storage medium.

### BACKGROUND OF THE DISCLOSURE

A video client is a client whose installation rate and utilization rate are relatively high in a terminal. A user may watch a series, a movie, a variety show, and the like through the video client.

A play interface of the video client usually includes a video player, a play control region, and a play list region. The video player can be used for playing a video. The play control region can be used for displaying play controls, such as a progress bar control, a volume control, and a picture quality selection control. The play list region can be used for displaying a play list and video related information.

In an example, after a video is completely played, the video client hides the video player. In addition, to improve a click-through rate of another video, the video client displays a recommended video in the interface, so that the user can click and watch the recommended video.

When video recommendation is performed in the foregoing manner, recommended content is not displayed unless a current video is completely played. However, the user usually does not watch the entire video from the beginning to the end, and consequently an exposure rate and a click-through rate of the recommended content are relatively low.

### SUMMARY

Embodiments of this application provide a recommended content display method and apparatus, a terminal, and a computer-readable storage medium.

In an exemplary embodiment, a recommended content display method is provided that can be performed by a terminal. The method can include playing a target video in a video play region of a video player, reducing a size of the video play region when the target video is played to closing credits, and displaying, in the video player, the video play region whose size is reduced and recommended content. The video play region whose size is reduced can be used for continuing to play the target video.

In another exemplary embodiment, a recommended content display apparatus can include processing circuitry that is configured to play a target video in a video play region of a video player, reduce a size of the video play region when that the target video is played to closing credits, and display, in the video player, the video play region whose size is reduced and recommended content. The video play region whose size is reduced can be used for continuing to play the target video.

In alternative exemplary embodiments, a terminal is provided. The terminal can include a processor and a memory that stores at least one instruction, at least one program, a code set, or an instruction set. The at least one instruction, the at least one program, the code set, or the instruction set can be executed by the processor to perform the operations of the above described recommended content display method.

In an embodiment, a non-transitory computer-readable storage medium is provided for storing at least one instruction, at least one program, a code set, or an instruction set. When executed by a processor, the at least one instruction, the at least one program, the code set, or the instruction set can cause the processor to perform the operations of the foregoing recommended content display method.

Details of one or more embodiments of this application are provided in the following accompanying drawings and descriptions. Other features and advantages of this application become more clear with reference to the specification, the accompanying drawings, and the claims.

### BRIEF DESCRIPTION OF THE DRAWINGS

To describe the technical solutions of the exemplary embodiments of this application more clearly, the following briefly introduces the accompanying drawings required for describing the embodiments. The accompanying drawings in the following description show only some embodiments of this application, and a person of ordinary skill in the art may still derive other drawings from the accompanying drawings.

FIG. 1 is a schematic diagram of an implementation environment according to an embodiment of this application.

FIG. 2a is a schematic diagram of a play interface of a video client.

FIG. 2b is a schematic interface diagram of a procedure of displaying recommended content in the related art.

FIG. 3 is a schematic interface diagram of a procedure of displaying recommended content according to an embodiment of this application.

FIG. 4 is a flowchart of a recommended content display method according to an embodiment of this application.

FIG. 5 is a flowchart of a recommended content display method according to another embodiment of this application.

FIG. 6 is a flowchart of a procedure of determining whether a target video satisfies a recommendation condition.

FIG. 7 is a schematic diagram of region division of a play interface according to an embodiment of this application.

FIG. 8 is a flowchart of a procedure of feeding back, by a backend server, recommended content to a video client.

FIG. 9 is a schematic diagram of video elements and full columns in a recommendation mode.

FIG. 10 is a schematic interface diagram of a procedure of switching between a play mode and a recommendation mode.

FIG. 11 is a flowchart of a recommended content display method according to another embodiment of this application.

FIG. 12 is a block diagram of a recommended content display apparatus according to an embodiment of this application.

FIG. 13 is a structural block diagram of a terminal according to an exemplary embodiment of this application.

### DESCRIPTION OF EMBODIMENTS

To make the objectives, technical solutions, and advantages of this application clearer and more understandable, this application is further described in detail below with reference to the accompanying drawings and the embodiments. It is to be understood that the specific embodiments described herein are merely examples used for explaining this application, but are not intended to limit this application.

FIG. 1 is a schematic diagram of an implementation environment according to an exemplary embodiment of this application. The implementation environment includes a terminal 110 and a server 120. The terminal 110 is an electronic device in which a video client is installed. The electronic device may be a smartphone, a tablet computer, a personal computer, or the like. In FIG. 1, descriptions are made by using an example in which the terminal 110 is a personal computer. The video client is a client providing a video on demand service and an online video play service.

After the terminal 110 starts the video client, the video client displays a main interface. The main interface includes videos ranked according to conditions, such as video types, video rankings, amounts of play of the videos, update time of the videos, and the popularity of the videos.

When a user selects one of the videos, the video client displays a play interface. The play interface may include a video player, a play control region, and a play list region. When the video player plays the video, the user may control the video player through play controls in the play control region. For example, the user may adjust a play time point by dragging a slider on a progress bar control, adjust a video play speed through a variable speed control, or adjust a video volume through a volume control. The play list region includes a play list and related information of the currently played video. The related information is, for example, a cast list, a director, or a rating of a movie.

The terminal 110 is connected to the server 120 through a wired network or a wireless network. The server 120 is a backend server of the video client. The server 120 may be a server, a server cluster including a plurality of servers, or a cloud computing center.

Optionally, the server 120 can include a video database. The video database stores video data, or a video path corresponding to video data (stored in another server). The server 120 provides the video data to the video client based on the video database. The server 120 can further include a user database. The user database stores correspondences between different user accounts and historical play records, membership levels, and user profile data. The server 120 performs content recommendation based on the user database.

Optionally, the server 120 may include a video information database. The video information database stores information of different videos. The information is, for example, amounts of play, rankings among videos of the same type, and ratings. The server 120 screens recommended content based on the video information database.

In a possible application scenario, as shown in FIG. 1, after running the video client, the terminal 110 obtains video data from the server 120, and parses and plays the video data. When the video is played to closing credits, the terminal 110 transmits a recommended content obtaining request to the server 120, to request to obtain recommended content from the server 120. After receiving the recommended content obtaining request, the server 120 determines the recommended content based on the user database 121 and the video information database 122, and then feeds back the recommended content to the terminal 110, so that the video client in the terminal 110 parses and displays the recommended content.

In another possible implementation, when the terminal 110 buffers recommended content, the terminal 110 obtains the recommended content from a buffer when the video is played to the closing credits, and parses and displays the recommended content without requesting the server 120.

Optionally, the wireless network or the wired network uses a standard communications technology and/or protocol. The network is generally the Internet, but may be any other network, including but not limited to a local area network (LAN), a metropolitan area network (MAN), a wide area network (WAN), a mobile, wired, or wireless network, or any combination of a dedicated network or a virtual dedicated network. In some embodiments, technologies and/or formats such as hypertext markup language (HTML) and extensible markup language (XML) are used for representing data exchanged through a network. In addition, all or some links may be encrypted by using conventional encryption technologies such as a secure socket layer (SSL), a transport layer security (TLS), a virtual private network (VPN), and Internet Protocol security (IPsec). In some other embodiments, custom and/or dedicated data communication technologies may also be used in place of or in addition to the foregoing data communication technologies.

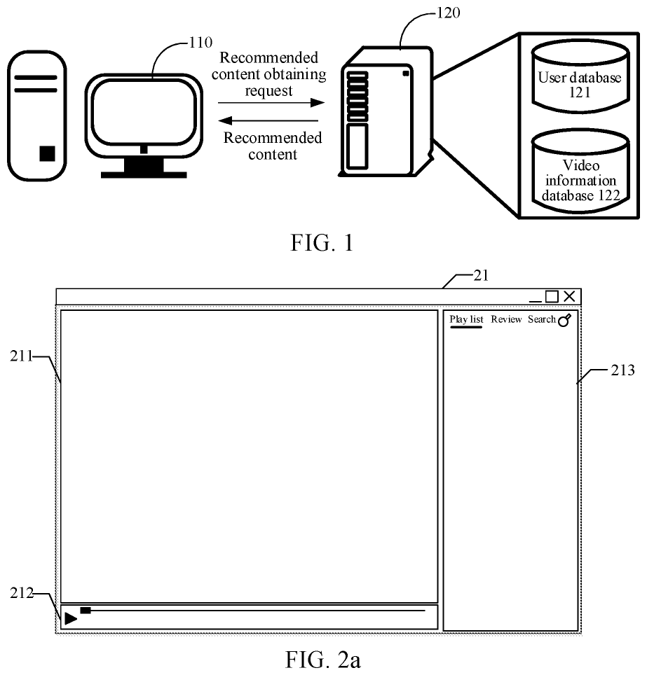

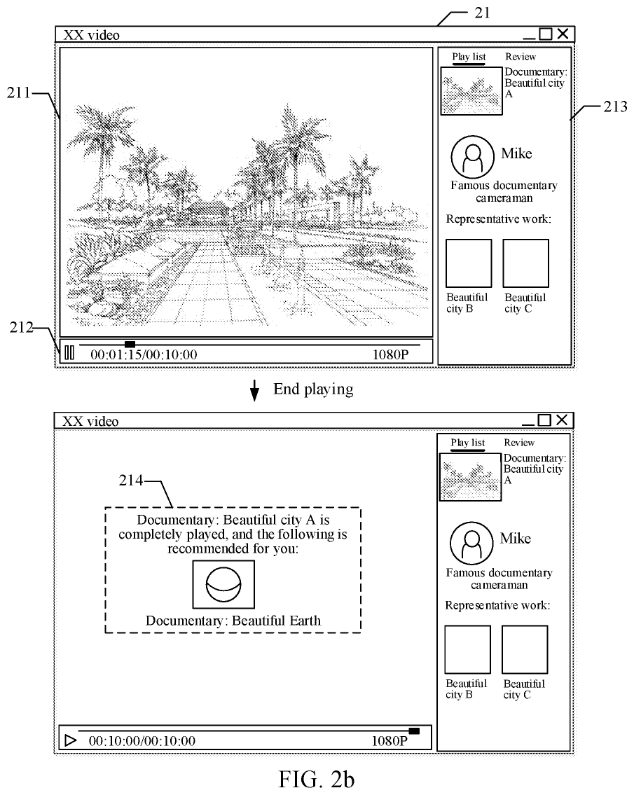

FIG. 2a is a schematic diagram of a play interface 21 of a video client according to an embodiment of this application. The play interface 21 includes a video player 211, a play control region 212, and a play list region 213. The video player 211 is configured to display at least one of a video picture and recommended content. The play control region 212 is configured to control a play state of a played video when the video is played, such as pausing, adjusting a play progress, and variable speed play. The play list region 213 is configured to present video information, such as a brief instruction of the video or a review by a user watching the video, of the played video. In addition, an online video may be further searched for in the play list region 213.

The video player 211 may include a recommendation region configured to display the recommended content and a video play region. When a video is played, a video picture is displayed in the video play region. The video play region may be displayed in the video player 211 in a full size, for example, fully occupying the region of the video player 211. Alternatively, the video play region may be displayed in a size smaller than that of the video player 211. For example, when the video is played to the closing credits, the size of the video play region is reduced in the video player 211, to simultaneously display the recommendation region.

When the video is normally watched, the recommendation region is usually not displayed, to prevent watching experience of the user from being affected. When the video is played to the closing credits, the video play region may be displayed in a reduced size, to simultaneously display the recommendation region.

The recommended content display method provided in the embodiments of this application may be individually performed by the video client in the terminal 110, or may be performed by the terminal 110 and the server 120 in cooperation. The following embodiments are described by using an example in which the recommended content display method is performed by the video client installed in the terminal 110.

As shown in FIG. 2b, when a user selects a video and plays the video, a play interface 21 of a video client includes a video player 211, a play control region 212, and a play list region 213. In a non-full-screen play mode, the video player 211 displays a video picture. The user may control a play progress through a play control in the play control region 212.

In the related art, after the current video is completely played, the video client hides the video player 211, and displays a recommendation region 214, which is used for presenting recommended content, in the interface, so that the user can click and watch the recommended content.

The recommended content cannot be exposed unless the current video is completely played. However, in an actual situation, for a video such as a television drama, a movie, a documentary, or a variety show, video content at the end of the video is usually a rolling subtitle or a trailer. The user does not pay much attention to the video content and usually quits the play interface 21 when the video is not completely played. As a result, an exposure rate of the recommended content is relatively low. In addition, the video client may perform data exchange with a backend server in advance, to obtain the recommended content. Therefore, the low exposure rate of the recommended content may lead to a waste of data transmission resources.

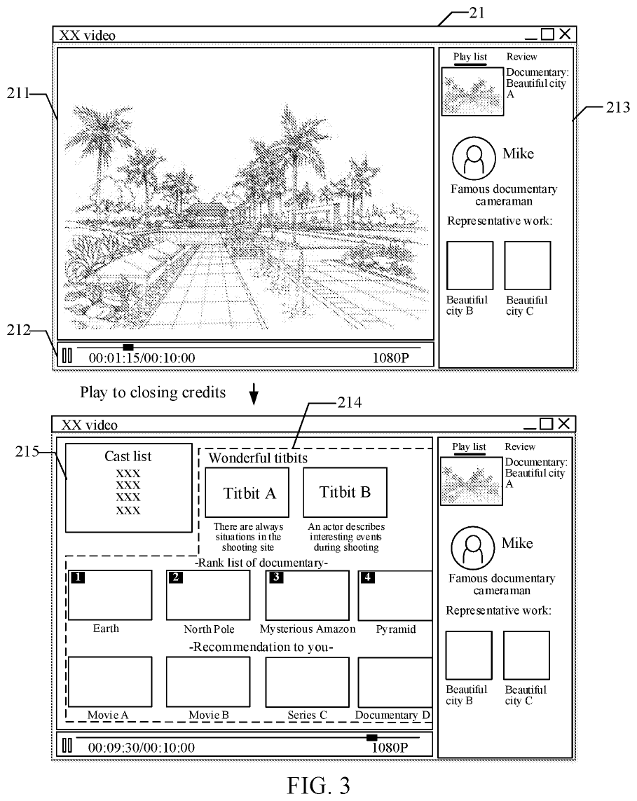

As shown in FIG. 3, in an exemplary embodiment of this application, in order to improve the exposure rate of the recommended content without affecting normal video watching of the user when detecting that the current video is played to the closing credits, the video client reduces a size of a video play region 215 in the video player 211, and moves the video play region 215 to a specified location of the video player 211 to continue to play the video. Simultaneously, the video client displays the recommended content in the recommendation region 214, for example a region other than the video play region 215, of the video player 211, to enable the user to select and watch the recommended content without affecting user's watching of the closing credits of the video. The following describes the recommended content display method provided in this embodiment of this application by using an exemplary embodiment.

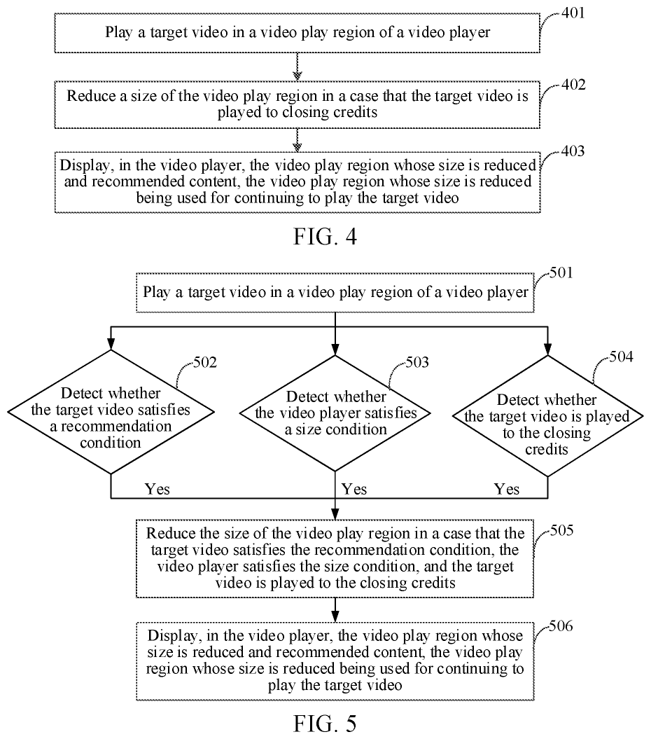

FIG. 4 is a flowchart of a recommended content display method according to an embodiment of this application. This embodiment uses an example, in which the method is applied to a terminal in which a video client is installed, for description, and the method may include the following steps.

In step 401, a target video can be played in a video play region of a video player. A play interface of the video client includes the video player. When a video is played by using the video client, the video client parses and renders received video data through the video player, to display a corresponding video picture in the video play region of the video player. Optionally, when the current video is not played to the closing credits, a size of the video play region is the same as that of the video player, or the size of the video play region is slightly smaller than that of the video player, that is, the video player displays only the video play region. As shown in FIG. 3, when the current video is not played to the closing credits, the video player 211 displays a video picture completely.

The target video in this embodiment of this application is the currently played video. The target video may be a television drama, a movie, a documentary, a cartoon, a music video (MV), a variety show, or an original video. Of course, the type of the target video is not limited in this embodiment of this application.

In step 402 a size of the video play region can be reduced in a case that the target video is played to closing credits. In a possible implementation, the video client obtains a closing credit time point corresponding to the target video, and determines, according to a current play time point of the target video and the closing credit time point, whether to play the target video to the closing credits. Optionally, after receiving a request for playing the target video, the video client obtains the closing credit time point corresponding to the target video. In another possible implementation, the video client may predict the closing credit time point according to a total video duration of the target video, or the video client may automatically recognize the closing credits of the video based on the video picture.

Optionally, the video client pre-stores a first size and a second size, where the first size is a display size (without taking account of manually scaling a window size of the video client) of the video play region when the video is normally played, and the second size is a target size to which the size of the video play region is reduced. When the closing credits are played, the video client reduces the size of the video play region from the first size to the second size.

When the size of the video play region is reduced, the video client can dynamically determine, according to a current window size, the target size to which the size of the video play region is reduced. Further, when detecting that the user manually positions the play time point to the closing credits through the play control, the video client determines that the user pays attention to the closing credits of the video, and the video client stops reducing the size of the video play region.

In step 403, display, in the video player, the video play region whose size is reduced and recommended content, the video play region whose size is reduced being used for continuing to play the target video. Optionally, before the closing credits are played, the video client transmits a recommended content obtaining request to the backend server, to obtain corresponding recommended content. Additionally, the recommended content may include at least one of the following: a video, an advertisement, and an application. A specific type of the recommended content is not limited in this embodiment of this application.

After reducing the size of the video play region and obtaining the recommended content, the video client renders and displays the video play region and the recommended content in the video player. In a possible implementation, as shown in FIG. 3, the video play region 215 whose size is reduced is displayed in a region in the upper left corner of the video player 211, and the recommended content 214 is displayed in another region of the video player 211. In another possible implementation, the video play region whose size is reduced may alternatively be displayed in a region in the upper right corner, a region in the lower left corner, a region in the lower right corner, or the like of the video player. A specific display location of the video play region whose size is reduced is not limited in this embodiment of this application.

The video client continues to play the closing credits of the target video through the video play region whose size is reduced, and receives a selection signal for the recommended content. In addition, the video play region whose size is reduced is still controlled by the play control in the play control region. That is, when receiving an operation signal for the play control in the play control region, the video play region adjusts the play progress according to the operation signal.

When the recommended content is displayed by using the method provided in this embodiment of this application, the recommended content is displayed when the video is played to the closing credits without waiting until the video is completely played, that is, a timing for displaying the recommended content is ahead of schedule, thereby improving an exposure rate of the recommended content, and avoiding a problem that the user closes the play interface after watching the closing credits, and consequently the recommended content cannot be exposed.

Based on the above, in this embodiment of this application, when a video is watched by using a video client, an entire video player is first filled with a video play region, to play the video in the entire video player. When the video is played to closing credits, a size of the video play region is reduced, to further simultaneously display the video play region whose size is reduced and recommended content in the video player, and continue to play the target video in the video play region whose size is reduced. Compared with the related art in which the recommended content is not displayed unless the video completely ends, in this embodiment of this application, without affecting normal video watching of the user, the size of the video play region is adjusted and content recommendation is performed in the video player, so that the user may see the recommended content during the closing credits of the video, thereby further improving the exposure rate of the recommended content.

In an application scenario, when using the video client to play a series, the user usually expects to continue to play a next video after a current video is completely played, and does not expect content recommendation after the current video is completely played. As a result, the video client further needs to detect whether the current video satisfies a recommendation condition, and perform the content recommendation when the current video satisfies the recommendation condition.

In addition, when the recommended content is displayed by using the foregoing method, the recommended content and the video picture are simultaneously displayed in the video player. Therefore, to ensure the clearness of the picture in the video play region, the video client further needs to determine, according to the size of the current video player, whether to perform the content recommendation.

In a possible implementation, the video client performs the content recommendation when the current video satisfies the recommendation condition, the size of the current video player satisfies a size condition, and the current video is played to the closing credits. A schematic embodiment is provided below for description.

FIG. 5 is a flowchart of an exemplary recommended content display method according to another embodiment of this application. This embodiment uses an example, in which the method is applied to a terminal in which a video client is installed, for description, and the method may include the following steps.

In step 501 a target video can be played in a video play region of a video player. For the implementation of this step, refer to the foregoing step 401.

In step 502, whether the target video satisfies a recommendation condition can be detected. In a possible implementation, when receiving a request for playing the target video, the video client detects whether the target video satisfies the recommendation condition. If the target video satisfies the recommendation condition, the video client performs step 505, and if the target video does not satisfy the recommendation condition, the video client does not perform the following recommendation step.

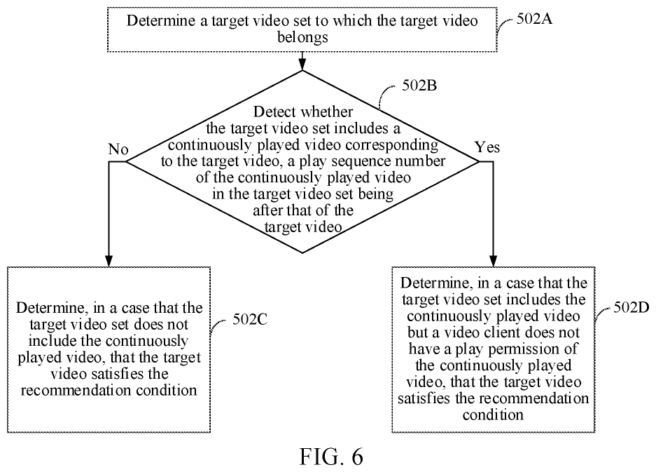

Because the user does not expect to be interrupted by the recommended content when watching continuous videos, in a possible implementation, a video play device detects whether the target video is a last episode of a video set to which the target video belongs. If the target video is the last episode of the video set to which the target video belongs, it is determined that the target video satisfies the recommendation condition. As shown in FIG. 6, this step may include the following steps.

In step 502A, a target video set to which the target video belongs can be determined. The target video set is a set of videos having a play time sequence relationship with the target video. Optionally, the target video set may be a set of a plurality of episodes of a series, a set of a plurality of episodes of a cartoon, a set of a movie series, or a set of a documentary series. The specific type of the target video set is not limited in this embodiment of this application. Further, the video client transmits a request to the backend server, to determine the target video set to which the target video belongs.

In step 502B, whether the target video set includes a continuously played video corresponding to the target video can be detected, a play sequence number of the continuously played video in the target video set being after that of the target video. Optionally, the target video set includes play sequence numbers and play permissions corresponding to videos. The play sequence numbers are used for indicating a play order of the videos. The play sequence numbers may be determined according to episode numbers corresponding to the videos. For example, a play sequence number corresponding to the first episode is before that corresponding to the second episode.

The play permission is used for indicating a lowest permission of a client capable of playing the video, and play permissions corresponding to different videos of the same video set may be the same, or may be different. For example, in series episodes corresponding to a series A, play permissions of the first episode to the tenth episode are registered users, and play permissions of the eleventh episode to the fifteenth episode are members.

Based on the determined target video set, the video client detects whether the target video set includes the continuously played video corresponding to the target video. If the continuously played video corresponding to the target video is not included, it indicates that the target video is a latest episode in the target video set, and it is determined that the target video satisfies the recommendation condition. If the continuously played video corresponding to the target video is included, it indicates that the target video is not the latest episode in the target video set, and it is determined that the target video does not satisfy the recommendation condition.

Optionally, when the continuously played video corresponding to the target video is included, the video client further determines whether the video client has a play permission of the continuously played video. If the video client has the play permission of the continuously played video (that is, the continuously played video can be continuously played after the target video is completely played), it is determined that the target video does not satisfy the recommendation condition. If the video client does not have the play permission of the continuously played video, it is determined that the target video satisfies the recommendation condition, and logic of granting the play permission of the continuously played video is performed. For example, when a non-member user watches a video, if a video next to the currently played video can only be watched by member users, it is determined that the video client does not have the play permission of the continuously played video, that is, the target video satisfies the recommendation condition.

In step 502C, in a case that the target video set does not include the continuously played video, that the target video satisfies the recommendation condition can be determined. When the target video set does not include the continuously played video, the video client determines that a next episode cannot be continuously played after the target video is completely played, so that it is determined that the target video satisfies the recommendation condition, and step 505 is performed. For example, when the target video set includes the first episode to the tenth episode of a series, and a current video is the tenth episode, the video client determines that the current video satisfies the recommendation condition.

In step 502D, in a case that the target video set includes the continuously played video but a video client does not have a play permission of the continuously played video, that the target video satisfies the recommendation condition can be determined. Optionally, when the target video set includes the continuously played video, the video client further detects whether the video client has the play permission of the continuously played video. If so, a continuous play operation is performed, and if not, after the current video is completely played, an operation of recommending granting the play permission of the continuously played video is performed.

For example, the target video set includes the first episode to the fifteenth episode of a series, where play permissions of the first episode to the tenth episode are registered users, and play permissions of the eleventh episode to the fifteenth episode are members. If a registered user logs in to an account of the video client, and the current video is the tenth episode, it is determined that the current video satisfies the recommendation condition, and a membership granting entry is displayed in the recommended content when the current video is played to the closing credits.

In another possible implementation, when the target video set includes the continuously played video, but the video client does not have the play permission of the continuously played video, the video client may alternatively determine that the recommendation condition is not satisfied, and recommend granting the play permission of the continuously played video after the target video is completely played.

In step 503, whether the video player satisfies a size condition can be detected. In a possible implementation, when the target video is played, the video client obtains a size of the video player, and detects whether the size of the video player is greater than a size threshold. If the size of the video player is greater than a size threshold, it is determined that the video picture can be clearly displayed when the content recommendation is performed, and the following step 505 is performed. If the size of the video player is less than a size threshold, it is determined that the video picture cannot be clearly displayed when the content recommendation is performed, and the following recommendation step is stopped from being performed. For example, the size threshold includes a length size threshold 640 px and a height size threshold 435 px.

Optionally, the size threshold may be related to a video resolution of the target video. For example, when the video resolution is 1080p, the size threshold is 640 px×435 px, and when the video resolution is 720p, the size threshold is 600 px×400 px. Further, because the size of the video player changes with the window size of the video client, the video client may perform the step of size detection when detecting that the target video is played to the closing credits or that the target video is about to be played to the closing credits.

In step 504, whether the target video is played to the closing credits can be detected. In a possible implementation, the video client may use any one of the following three manners to detect whether the target video is played to the closing credits.

The first way can be to obtain a closing credit time point of the target video, the closing credit time point being a start time point of playing the closing credits, and reduce the size of the video play region in a case that the target video is played to the closing credit time point. In order to help the user to quickly skip opening credits and closing credits of a video in a procedure of continuously playing videos, the video includes a corresponding opening credit time point and a corresponding closing credit time point. The opening credit time point is a time point at which the opening credits end, and the closing credit time point is a start time point at which a feature film ends and the closing credits are played. Optionally, the opening credit time point and the closing credit time point are manually annotated, or generated according to click behavior, for example fast-forwarding to the feature film and manually closing at the closing credits, of a large number of users during video watching.

In a possible implementation, when obtaining target video data from the backend server, the video client simultaneously obtains, from the backend server, the closing credit time point of the target video, detects, when the target video is played, whether the current play time point reaches the closing credit time point, and reduces the size of the video play region when the current play time point reaches the closing credit time point. For example, if the video client obtains that the closing credit time point of the target video is 01:40:32, when the video is played to 1 hour, 40 minutes, and 32 seconds, it is determined that the video enters the closing credits, and the size of the video player is reduced.

The second way can be to obtain a total video duration of the target video, determine a predicted closing credit time point according to the total video duration, and reduce the size of the video play region in a case that the target video is played to the predicted closing credit time point. Because not all videos are provided with a closing credit time point in advance, in a possible implementation, when the closing credit time point corresponding to the target video is not obtained, the video client obtains the total video duration of the target video, and further determines the predicted closing credit time point based on the total video duration.

In a possible implementation, because the closing credits of the video usually occupies only a relatively short duration, and duration proportions occupied by closing credits of videos of different types are different, the video client determines a closing credit duration proportion of the closing credits of the video according to the video type of the target video, and further determines the predicted closing credit time point according to the closing credit duration proportion and the total video duration. For example, when the video client obtains that the total video duration of the target video is 90 minutes, and that the type of the target video is a movie, the video client determines, according to 5%, which is a closing credit duration proportion corresponding to the video type of a movie, that the duration of the closing credits is 4.5 minutes, and further determines that the closing credit time point is 85 minutes and 30 seconds. When the target video is played, the video client detects whether the current play time point reaches the predicted closing credit time point, and reduces the size of the video play region when the current play time point reaches the predicted closing credit time point.

The third way can be to reduce the size of the video play region in a case that a video picture satisfies a closing credit feature. The closing credit feature including at least one of a closing credit subtitle feature and a closing credit picture feature. Generally, the closing credits of the video include a large number of subtitles, and a picture feature of a closing credit picture of the video is greatly different from that of a feature film picture of the video. Therefore, in a possible implementation, when the closing credit time point corresponding to the target video is not obtained, the video client detects whether the video picture satisfies the closing credit subtitle feature and/or the closing credit picture feature.

Optionally, the closing credit subtitle feature includes subtitle keywords. For example, the subtitle keywords include a cast list, a director, a role of an actor, a producer, and the like. Further, the closing credit picture feature can include picture color constitution, and a proportion of a target color. For example, when picture color constitution of the video picture is black and white, and a proportion of black (the target color) reaches 80%, the video client determines that the video picture satisfies the closing credit feature. In another possible implementation, the video client may alternatively determine, according to an ending song feature, whether the video is currently played to the closing credits. Of course, this is not limited in this exemplary embodiment of this application.

In step 505, the size of the video play region in a case that the target video satisfies the recommendation condition can be reduced, the video player satisfies the size condition, and the target video is played to the closing credits. When the recommendation condition and the size condition are simultaneously satisfied, and the closing credits are played, the video client performs the operation of reducing the size of the video play region. For the step of reducing the size of the video play region, refer to step 302. In this embodiment, only an example, in which the recommended content is displayed when the foregoing three conditions are simultaneously satisfied, can be used for description. In another possible implementation, when the closing credits are played and the video play region satisfies the size condition, or when the closing credits are played and the target video satisfies the recommendation condition, the video client may display the recommended content.

In step 506, in the video player, the video play region whose size is reduced and recommended content can be displayed, the video play region whose size is reduced being used for continuing to play the target video. Generally, a user interface (UI) framework of the video client is undiversified, which is adverse to display of the recommended content. However, in the embodiments of this application, by resetting the UI framework, the video player is enabled to display different content in a play mode and a recommendation mode.

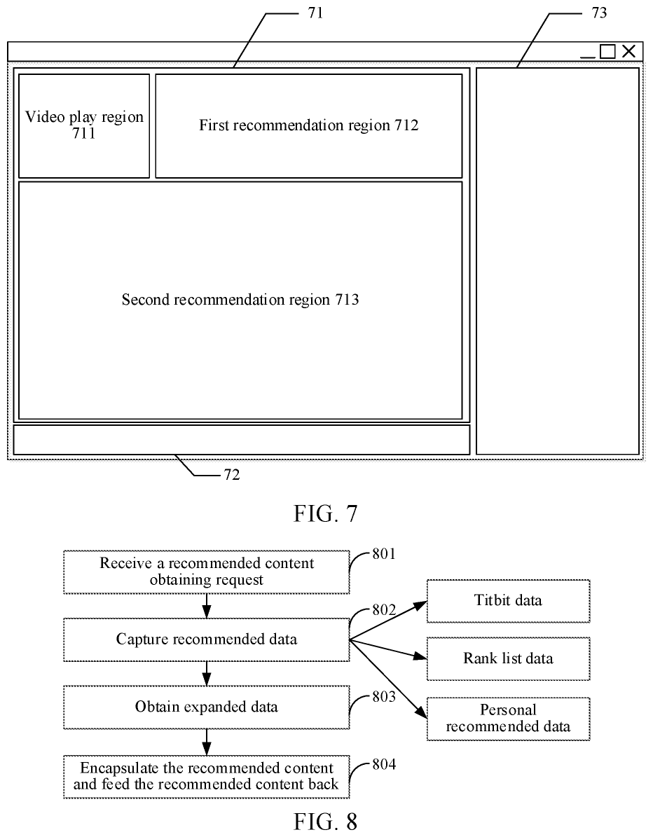

As shown in FIG. 7, the play interface of the video client includes a video player 71, a play control region 72, and a play list region 73. The video player 71 includes a video play region 711, a first recommendation region 712, and a second recommendation region 713. In addition, an initial state (default state) of the video play region 711 is a shown state (show), and initial states of the first recommendation region 712 and the second recommendation region 713 are hidden states (hide). Correspondingly, when the video client simultaneously displays the recommended content and the video player, the following steps can be included.

A first step is to display, in the video player, the video play region whose size is reduced. In this embodiment, the size of the video play region in the video player is variable. When a trigger condition of displaying the recommended content is not satisfied, the size of the video play region is consistent with the size of the video player, that is, the video play region is automatically expanded to the entire video player. In addition, because the initial states of the first recommendation region and the second recommendation region are both hidden states, the video picture is not affected.

When the trigger condition of displaying the recommended content is satisfied, to display the recommended content in the video player, the video client displays the video play region whose size is reduced in a preset location of the video player. The preset location may be the upper left corner, the upper right corner, the lower left corner, the lower right corner, or the like of the video player. This embodiment uses an example, in which the video play region whose size is reduced is displayed in the upper left corner of the video player, for description.

The second step is to set the first recommendation region to be in the shown state, and display first recommended content in the first recommendation region, the first recommended content including a video associated with the target video. Because the initial state of the first recommendation region is the hidden state, to make the recommended content in the first recommendation region visible, the video client first sets the first recommendation region to be in the shown state, and then displays the obtained first recommended content in the first recommendation region.

In a possible implementation, because the first recommendation region and the video play region are neighboring, and are at the same height, the video associated with the target video is displayed in the first recommendation region. For example, when the target video is a movie or a television drama, the first recommended content is a trailer, a titbit, or the like of the target video. Specific content of the first recommended content is not limited in this embodiment of this application. In a possible implementation, an outer layer of the first recommendation region only provides an empty frame: BlooperWrapper, and a video element item (the titbit) is created in the BlooperWrapper through an independently created type (a titbit type).

A third step is to set the second recommendation region to be in the shown state, and display second recommended content in the second recommendation region, the second recommended content including a ranking video and a recommended video, the ranking video and the target video belonging to the same video type, and the recommended video being determined according to a historical play record of the video client. Because the initial state of the second recommendation region is also the hidden state, to make the recommended content in the second recommendation region visible, the video client first sets the second recommendation region to be in the shown state, and then displays the obtained second recommended content in the second recommendation region.

In a possible implementation, an outer layer of the second recommendation region only provides an empty frame: RecommendContainer, and a video element item (the ranking video and the recommended video) is created in the RecommendContainer through an independently created type (a recommended type).

In a manner of obtaining the second recommended content, the video client obtains, according to a video type to which the target video belongs, a rank list corresponding to the video type, and further determines ranking videos in the rank list as the second recommended content. The video client determines play amounts corresponding to various video types according to the historical play record, to determine n target video types of the most play amounts, and further determines videos corresponding to the n target video types as the second recommended content (that is, the recommended videos), where n is a positive integer. A specific manner of determining the second recommended content is not limited in this embodiment of this application.

Optionally, the obtaining, by the video client, the recommended content can include the following steps.

First, the video client can check whether the recommended content is locally buffered. Then, the video client can directly read the recommended content from a local buffer if the recommended content is locally buffered. Further, the video client can transmit a recommended content obtaining request to the backend server if the recommended content is not locally buffered. Finally, the video client can perform format check on the received recommended content, and parse and buffer the recommended content locally after the check is passed.

In an example, as shown in FIG. 8, the feeding, by the server, the recommended content back to the video client can include step 801 where the recommended content obtaining request can be received. In step 802, recommended data according to the recommended content obtaining request can be captured, the recommended data including titbit data, rank list data, and personal recommended data. In step 803, corresponding expanded data when the recommended data is successfully captured can be obtained, the expanded data being used for adding extra information (including information such as a badge or a rating of a recommended item). Finally, in step 804, the recommended data and the expanded data into the recommended content can be encapsulated, and feed the recommended content back to the video client.

In this embodiment, when the target video satisfies the recommendation condition, the video player satisfies the size condition, and the target video is played to the closing credits, the video client simultaneously displays the video play region whose size is reduced and the recommended content, thereby preventing the content recommendation from being performed in a procedure of continuous video play, and ensuring the clearness of the video picture displayed by the video player.

In this embodiment, though the flexible UI interface framework, the video play region of the video player is displayed in an enlarged size in the play mode, and the first recommendation region and the second recommendation region (which display the recommended content) are hidden, and the video play region of the video player is displayed in a reduced size in the recommendation mode, and the first recommendation region and the second recommendation region are displayed, so that the exposure rate of the recommended content is improved without affecting normal watching of the user.

Optionally, after the video player and the recommended content are simultaneously displayed, when the target video is completely played, the video client plays the first recommended content through the video play region whose size is reduced, and updates the first recommended content displayed in the first recommendation region.

Exemplarily, with reference to FIG. 3 and FIG. 7, after the target video is completely played, the video play region 215 sequentially plays a titbit A and a titbit B in the recommended content 214, and updates a titbit video in the first recommendation region 712.

In another possible implementation, to achieve a better play effect, the video client may enlarge the video play region, and play the first recommended content in the enlarged video play region. In another example, the video play region is enlarged in a case of receiving a selection signal for the first recommended content or the second recommended content, and the selected first recommended content or second recommended content is played through the enlarged video play region.

After the selection signal for the recommended content is received, it indicates that the user strongly intends to watch the recommended content. Therefore, the video client enlarges the video play region, and plays the selected recommended content in the enlarged video play region, to achieve a relatively good play effect. Optionally, after the video play region is enlarged, the video player includes only the video picture, and the recommended content is hidden. Alternatively, after the video play region is enlarged, the video player simultaneously includes the video picture and the recommended content, and a display size of the recommended content is proportionally reduced. A proportion of scaling up and scaling down may be adjusted by the user.

Exemplarily, with reference to FIG. 3 and FIG. 7, when a selection signal for the ranking video in the recommended content 214 is received, the video client expands the video play region 711 to the entire video player 71 (the first recommendation region 712 and the second recommendation region 713 are hidden), and restores the video play region, to play the selected ranking video through the restored video play region.

Optionally, to improve the click-through rate of the subsequent recommended content, and reduce interference caused to the user because of pushing content that does not satisfy the preference of the user, the video client generates user profile updated data according to operations performed by the user in the video player. The operations performed by the user in the video player include, but are not limited to, a staying operation, a click operation, a closing operation, and the like.

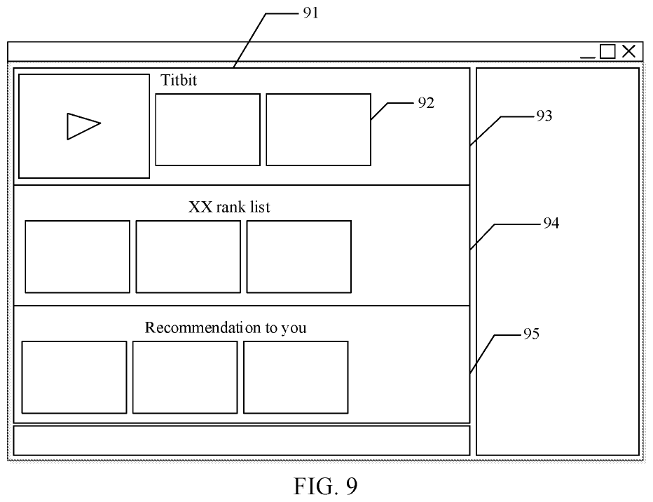

As shown in FIG. 9, in the recommendation mode in which the video player and the recommended content are simultaneously displayed, a video player 91 includes a plurality of video elements 92. Each of the video elements 92 is used for presenting video information such as a cover of a video, a watching permission badge, such as membership or VIP, a video name, a rating, or a rank list, and is used for responding to a click operation of the user. The plurality of video elements 92 at the same display height are combined to constitute a group of video content, and constitute a full column together with a related title, such as Titbit, Rank List, and Recommendation To You. FIG. 9 includes a Titbit full column 93, a Rank List full column 94, and a Recommendation To You full column 95.

In a manner of drawing the recommended content, the video client submits recommended data of various layers to corresponding layers on the UI, to ensure that the layers draw only the received recommended data without paying attention to data of another layer. For example, in FIG. 9, data of EndRecomendInfoItemList (including data related to a full column, such as a full column title or a full column type) is submitted to a full column layer, so that the full column layer draws full column content. Data of EndRecomendInfoItem (including video information such as a cover address of a video element or a video name) is submitted to a video element layer, so that the video element layer draws video elements.

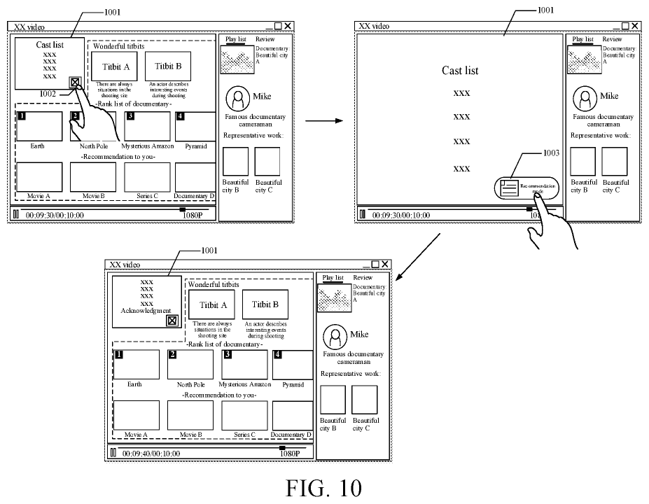

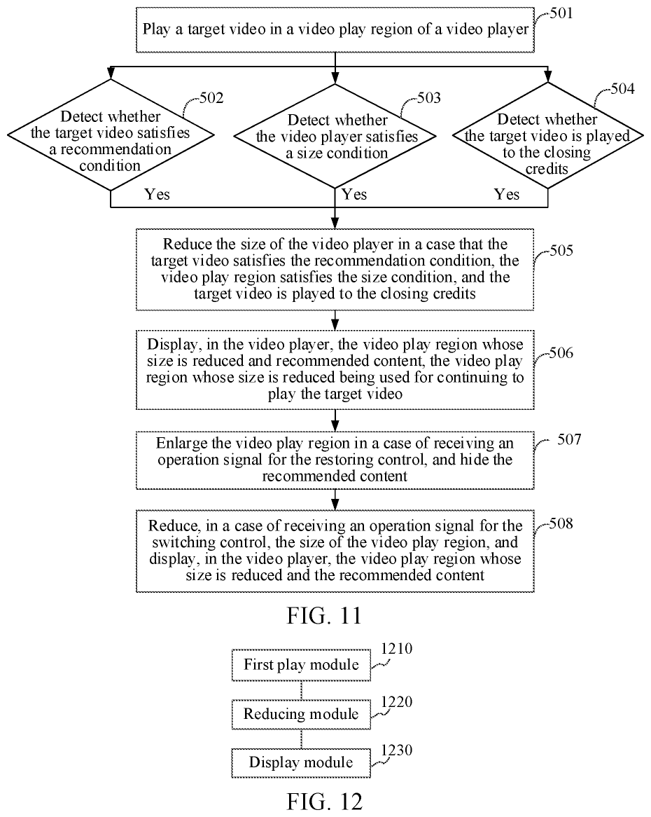

For ease of switching from the recommendation mode to the play mode to continue to watch the target video, as shown in FIG. 10, a video play region 1001 whose size is reduced includes a restoring control 1002. Correspondingly, as shown in FIG. 11, after step 506, the following step can be included.

In step 507, the video play region in a case of receiving an operation signal for the restoring control can be enlarged. When the user needs to watch the closing credits of the target video in a larger display region, the restoring control in the video play region may be triggered. Correspondingly, when receiving the operation signal for the restoring control, the video client enlarges the size of the video play region, and hides the recommended content. Optionally, the enlarged size of the video play region is the same as the size of the video player, or slightly smaller than the size of the video player.

With reference to step 506, the video client resets the first recommendation region and the second recommendation region in the video player to be in the hidden state, and expands the video play region to the video player. By using the restoring control in the video play region whose size is reduced, the switching from the recommendation mode to the play mode may be implemented. To further implement the switching from the play mode to the recommendation mode, optionally, as shown in FIG. 10, the restored video play region 1001 further includes a switching control 1003. Correspondingly, after step 507, the following step is further included.

In step 508, in a case of receiving an operation signal for the switching control, the size of the video play region can be reduced, and display, in the video player, the video play region whose size is reduced and the recommended content. When the user intends to view the recommended content again, the switching control in the video play region may be triggered. Correspondingly, when receiving the operation signal for the switching control, the video client reduces the size of the video play region. For the step of reducing the size of the video play region, refer to step 402.

With reference to step 506, the video client resets the first recommendation region and the second recommendation region in the video player to be in the shown state, and reduces the size of the video play region to a preset size, so that the video player simultaneously displays the video play region and the recommended content. In this embodiment, by disposing a restoring button in the video play region whose size is reduced, and disposing a switching button in the enlarged video play region, free switching between the play mode and the recommendation mode is implemented, thereby helping the user select a corresponding display mode as needed.

It is to be understood that, steps in flowcharts of FIG. 4 to FIG. 6 are displayed in sequence based on indication of arrows, but the steps are not necessarily performed in sequence based on a sequence indicated by the arrows. Unless explicitly specified in this application, execution of the steps is not strictly limited, and the steps may be performed in other sequences. In addition, at least some steps in FIG. 4 to FIG. 6 may include a plurality of substeps or a plurality of stages. The substeps or the stages are not necessarily performed at a same moment, and instead may be performed at different moments. A performing sequence of the substeps or the stages is not necessarily performing in sequence, and instead may be performing in turn or alternately with another step or at least some of substeps or stages of the another step.

The following is an apparatus embodiment of this application, which can be used to execute the method embodiments of this application. For details not disclosed in the apparatus embodiment of this application, reference may be made to the method embodiments of this application.

FIG. 12 is a block diagram of an exemplary content display apparatus according to an embodiment of this application. The apparatus has functions of performing the foregoing recommended content display method examples. The functions may be implemented by using hardware, or may be implemented by hardware executing corresponding software. The apparatus may include a first play module 1210 that is configured to play a target video in a video play region of a video player, a reducing module 1220 that is configured to reduce a size of the video play region in a case that the target video is played to closing credits, and a display module 1230 that is configured to display, in the video player, the video play region whose size is reduced and recommended content, the video play region whose size is reduced being used for continuing to play the target video. Of course, in exemplary embodiments, the one or more modules of this disclosure can be implemented by processing circuitry.

The apparatus can further include a first detection module that is configured to detect whether the target video satisfies a recommendation condition, and the reducing module 1220 is further configured to perform, in a case that the target video satisfies the recommendation condition, the operation of reducing a size of the video play region in a case that the target video is played to closing credits.

Further, the first detection module can include a video set determining unit that is configured to determine a target video set to which the target video belongs, a detection unit that is configured to detect whether the target video set includes a continuously played video corresponding to the target video, a play sequence number of the continuously played video in the target video set being after that of the target video, and a determining unit that is configured to determine, in a case that the target video set does not include the continuously played video, that the target video satisfies the recommendation condition.

The reducing module 1220 can include an obtaining unit that is configured to obtain a closing credit time point of the target video, the closing credit time point being a start time point of playing the closing credits, and a first reducing unit that is configured to reduce the size of the video play region in a case that the target video is played to the closing credit time point. Optionally, the reducing module 1220 may further include a second reducing unit, configured to obtain a total video duration of the target video, determine a predicted closing credit time point according to the total video duration, and reduce the size of the video play region in a case that the target video is played to the predicted closing credit time point. Additionally, the reducing module 1220 can include a third reducing unit that is configured to reduce the size of the video play region in a case that a video picture satisfies a closing credit feature, the closing credit feature including at least one of the following: a closing credit subtitle feature and a closing credit picture feature.

In an embodiment, the apparatus can further include a size obtaining module that is configured to obtain a size of the video player. Further, the reducing module 1220 can be configured to perform, in a case that the size of the video player is greater than a size threshold, the operation of reducing a size of the video play region in a case that the target video is played to closing credits.

Optionally, the video play region whose size is reduced includes a restoring control. The apparatus can further include and enlarging module that is configured to enlarge the video play region in a case of receiving an operation signal for the restoring control.

Optionally, the enlarged video play region includes a switching control. The apparatus further includes a switching module that is configured to reduce, in a case of receiving an operation signal for the switching control, the size of the video play region, and display, in the video player, the video play region whose size is reduced and the recommended content.

In an exemplary embodiment, the video player can include the video play region, a first recommendation region, and a second recommendation region, an initial state of the video play region being a shown state, and initial states of the first recommendation region and the second recommendation region being hidden states. Further, the display module 1230 can include a first display unit that is configured to display the video play region whose size is reduced in a preset location of the video player, and a second display unit that is configured to set the first recommendation region to be in the shown state, and display first recommended content in the first recommendation region, the first recommended content including a video associated with the target video. Additionally, the display module can include a third display unit that is configured to set the second recommendation region to be in the shown state, and display second recommended content in the second recommendation region, the second recommended content including a ranking video and a recommended video, the ranking video and the target video belonging to the same video type, and the recommended video being determined according to a historical play record of the video client.

Optionally, the apparatus further includes a second play module that is configured to play, in a case that the target video is completely played, the first recommended content through the video play region whose size is reduced, and update the first recommended content displayed in the first recommendation region. The apparatus can further include a third play module that is configured to enlarge, in a case of receiving a selection signal for the first recommended content or the second recommended content, the video play region, and play the selected first recommended content or second recommended content through the enlarged video play region.

The recommended content display apparatus may be implemented in a form of a computer program, and the computer program may be run on a terminal. A storage medium of the terminal may store program modules forming the recommended content display apparatus, for example, the first play module 1210, the reducing module 1220, and the display module 1230 shown in FIG. 7. The computer program formed by the program modules, when run by a processor, causes the processor to perform the operations of the recommended content display method according to the embodiments of this application.

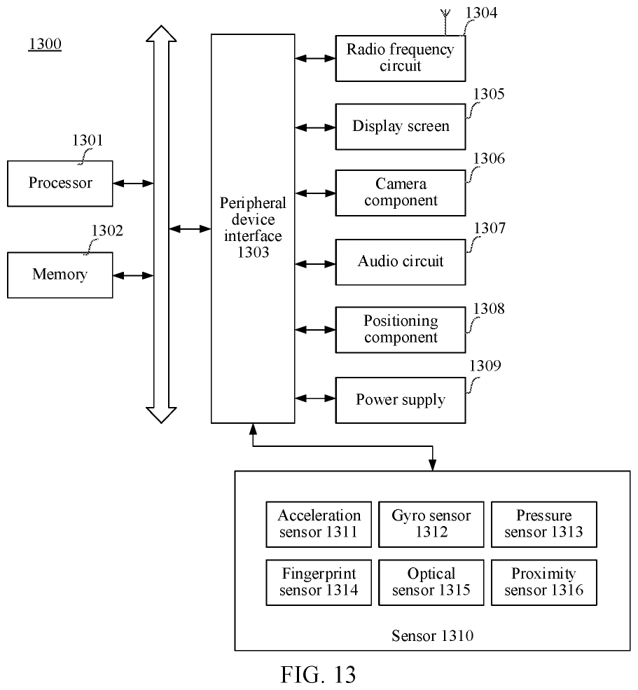

FIG. 13 is a structural block diagram of a terminal 1300 according to an exemplary embodiment of this application. The terminal 1300 may be a smartphone, a tablet computer, or a personal computer. Generally, the terminal 1300 includes processing circuitry, such as a processor 1301, and a memory 1302.

The processor 1301 may include one or more processing cores, for example, a 4-core processor or an 8-core processor. The processor 1301 may be implemented in at least one hardware form of digital signal processing (DSP), a field programmable gate array (FPGA), and a programmable logic array (PLA). The processor 1301 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1301 may be integrated with a graphics processing unit (GPU). The GPU is configured to be responsible for rendering and drawing content that a display screen needs to display. In some embodiments, the processor 1301 may further include an artificial intelligence (AI) processor. The AI processor is configured to process a computing operation related to machine learning.

The memory 1302 may include one or more computer-readable storage media. The computer-readable storage medium may be a non-volatile memory and/or a volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external high-speed buffer memory. By way of illustration and not limitation, the RAM is available in a variety of forms, such as a static RAM (SRAM), a dynamic RAM (DRAM), a synchronous DRAM (SDRAM), a dual data rate SDRAM (DDR SDRAM), an enhanced SDRAM (ESDRAM), a synchronization link (Synchlink) DRAM (SLDRAM), a memory Bus (Rambus) direct RAM (RDRAM), a direct memory bus dynamic RAM (DRDRAM), and a memory bus dynamic RAM (RDRAM). In some embodiments, the non-volatile computer-readable storage medium in the memory 1302 is configured to store at least one instruction, and the at least one instruction is configured to be executed by the processor 1301 to implement the recommended content display method provided in this application.

In some embodiments, the terminal 1300 may alternatively include: a peripheral device interface 1303 and at least one peripheral device. Specifically, the peripheral device include: at least one of a radio frequency circuit 1304, a touch display screen 1305, a camera 1306, an audio circuit 1307, a positioning component 1308, and a power supply 1309.

The peripheral device interface 1303 may be configured to connect input/output (I/O) related at least one peripheral device to the processor 1301 and the memory 1302. In some embodiments, the processor 1301, the memory 1302 and the peripheral device interface 1303 are integrated on a same chip or circuit board. In other some embodiments, any one or both of the processor 1301, the memory 1302, and the peripheral device interface 1303 may be implemented on a single chip or the circuit board. This is not limited in this embodiment.

The radio frequency circuit 1304 is configured to receive and transmit a radio frequency (RF) signal, which is also referred to as an electromagnetic signal. The RF circuit 1304 communicates with a communications network and other communications devices by using the electromagnetic signal. The RF circuit 1304 converts an electrical signal into the electromagnetic signal to send, or converts a received electromagnetic signal into the electrical signal. Optionally, the RF circuit 1304 can include an antenna system, an RF transceiver, one or more amplifiers, a tuner, an oscillator, a digital signal processor, a codec chip set, a subscriber identity module card, memory, and the like. The RF circuit 1304 may communicate with other terminals through at least one wireless communication protocol.

The wireless communication protocol includes, but is not limited to: a world wide web, a metropolitan area network, an intranet, generations of mobile communication networks (2G, 3G, 4G, and 5G), a wireless local area network and/or a Wi-Fi network. In some embodiments, the RF circuit 1304 may also include a circuit related to near field communication (NFC). This is not limited in this application.

The touch display screen 1305 is configured to display a user interface (UI). The UI may include a graphic, a text, an icon, a video, and any combination thereof. The touch display screen 1305 also has a capability of collecting a touch signal on or above a surface of the touch display screen 1305. The touch signal may be input to the processor 1301 for processing as a control signal. The touch display screen 1305 is configured to provide a virtual button and/or a virtual keyboard, which is also referred to as a soft button and/or a soft keyboard. In some embodiments, there may be one touch display screen 1305, disposed on a front panel of the terminal 1300. In some other embodiments, there may be at least two touch display screens 1305, disposed on different surfaces of the terminal 1300 respectively or in a folded design. In some more embodiments, the touch display screen 1305 may be a flexible display screen, disposed on a curved surface or a folded surface of the terminal 1300. Even, the touch display screen 1305 may be further set in a non-rectangular irregular pattern, namely, a special-shaped screen. The touch display screen 1305 may be made of a material such as a liquid crystal display (LCD) or an organic light-emitting diode (OLED).

The camera component 1306 is configured to collect an image or a video. Optionally, the camera component 1306 includes a front-facing camera and a rear-facing camera. Generally, the front-facing camera is configured to implement a video call or self-portrait. The rear-facing camera is configured to shoot a picture or a video. In some embodiments, there are at least two rear-facing cameras, each of which is any one of a main camera, a depth of field camera and a wide-angle camera, so as to implement a background blurring function by fusing the main camera and the depth of field camera, and panoramic shooting and virtual reality (VR) shooting functions by fusing the main camera and the wide-angle camera. In some embodiments, the camera component 1306 may further include a flash. The flash may be a monochrome temperature flash, or may be a double color temperature flash. The double color temperature flash refers to a combination of a warm light flash and a cold light flash, and may be used for light compensation under different color temperatures.

The audio circuit 1307 is configured to provide an audio interface between a user and the terminal 1300. The audio circuit 1307 may include a microphone and a speaker. The microphone is configured to collect a sound wave of a user and an environment, and convert the sound wave into the electrical signal to input to the processor 1301 for processing, or to input to the radio frequency circuit 1304 for implementing voice communication. For stereo collection or noise reduction, there may be a plurality of microphones, disposed at different portions of the terminal 1300 respectively. The microphone may be further an array microphone or an omni-directional collection type microphone. The speaker is configured to convert the electrical signal from the processor 1301 or the radio frequency circuit 1304 into the sound wave. The speaker may be a conventional film speaker, or may be a piezoelectric ceramic speaker. When the speaker is the piezoelectric ceramic speaker, not only the electric signal can be converted into a sound wave audible to a human being, but also the electric signal can be converted into a sound wave inaudible to the human being for ranging and the like. In some embodiments, the audio circuit 1307 may also include an earphone jack.

The positioning component 1308 is configured to position a current geographic location of the terminal 1300 for implementing navigation or a location based service (LBS). The positioning component 1308 may be a positioning component based on a global positioning system (GPS) of the United States, a Beidou navigation satellite system of China, GLONASS of Russia, or the Galileo system of the European Union.

The power supply 1309 is configured to supply power for various components in the terminal 1300. The power supply 1309 may be an alternating current, a direct current, a disposable battery, or a rechargeable battery. When the power supply 1309 includes a rechargeable battery, the rechargeable battery may be a wired rechargeable battery or a wireless rechargeable battery. The wired rechargeable battery is a battery charged through a wired line, and the wireless rechargeable battery is a battery charged through a wireless coil. The rechargeable battery may be further configured to support a fast charge technology.

In some embodiments, the terminal 1300 may also include one or more sensors 1310. The one or more sensors 1310 include, but are not limited to an acceleration sensor 1311, a gyro sensor 1312, a pressure sensor 1313, a fingerprint sensor 1314, an optical sensor 1315, and a proximity sensor 1316.

The acceleration sensor 1311 may detect the magnitude of acceleration on three coordinate axes of a coordinate system established with the terminal 1300. For example, the acceleration sensor 1311 may be configured to detect a component of gravity acceleration on the three coordinate axes. The processor 1301 may control, according to a gravity acceleration signal collected by the acceleration sensor 1311, the touch display screen 1305 to display the user interface in a transverse view or a longitudinal view. The acceleration sensor 1311 may be further configured to collect game or user motion data.

The gyro sensor 1312 may detect a body direction and a rotation angle of the terminal 1300. The gyro sensor 1312 may cooperate with the acceleration sensor 1311 to collect a 3D action by the user on the terminal 1300. The processor 1301 may implement the following functions according to the data collected by the gyro sensor 1312: motion sensing (such as changing the UI according to a tilt operation of the user), image stabilization at shooting, game control, and inertial navigation.

The pressure sensor 1313 may be disposed at a side frame of the terminal 1300 and/or a lower layer of the touch display screen 1305. When the pressure sensor 1313 is disposed at the side frame of the terminal 1300, a holding signal of the user on the terminal 1300 may be detected, and left/right hand identification and a quick action may be performed according to the holding signal. When the pressure sensor 1313 is disposed at the lower layer of the touch display screen 1305, an operable control on the UI interface can be controlled according to a pressure operation of the user on the touch display screen 1305. The operable control includes at least one of a button control, a scroll-bar control, an icon control and a menu control.

The fingerprint sensor 1314 is configured to collect a user's fingerprint to identify a user's identity according to the collected fingerprint. When identifying that the user's identity is a trusted identity, the processor 1301 authorizes the user to perform related sensitive operations. The sensitive operations includes: unlocking a screen, viewing encryption information, downloading software, paying and changing a setting, and the like. The fingerprint sensor 1314 may be disposed on a front surface, a back surface, or a side surface of the terminal 1300. When a physical button or a vendor logo is disposed on the terminal 1300, the fingerprint sensor 1314 may be integrated with the physical button or the vendor logo.

The optical sensor 1315 is configured to collect ambient light intensity. In an embodiment, the processor 1301 may control the display brightness of the touch display screen 1305 according to the ambient light intensity collected by the optical sensor 1315. Specifically, when the ambient light intensity is relatively high, the display brightness of the touch display screen 1305 is turned up. When the ambient light intensity is relatively low, the display brightness of the touch display screen 1305 is turned down. In another embodiment, the processor 1301 may further dynamically adjust a camera parameter of the camera component 1306 according to the ambient light intensity collected by the optical sensor 1315.

The proximity sensor 1316, also referred to as a distance sensor, is generally disposed on the front surface of the terminal 1300. The proximity sensor 1316 is configured to collect a distance between the user and the front surface of the terminal 1300. In an embodiment, when the proximity sensor 1316 detects that the distance between the user and the front surface of the terminal 1300 gradually becomes smaller, the touch display screen 1305 is controlled by the processor 1301 to switch from a bright screen state to an on-screen state. When the proximity sensor 1316 detects that the distance between the user and the front surface of the terminal 1300 gradually becomes larger, the touch display screen 1305 is controlled by the processor 1301 to switch from the on-screen state to the bright screen state.

A person skilled in the art may understand that a structure shown in FIG. 13 constitutes no limitation on the terminal 1300, and the terminal may include more or fewer components than those shown in the figure, or some components may be combined, or a different component deployment may be used.

An embodiment of this application further provides a computer-readable storage medium, such as a non-transitory computer-readable storage medium, storing at least one instruction, at least one program, a code set, or an instruction set, the at least one instruction, the at least one program, the code set, or the instruction set is loaded and executed by a processor to perform the recommended content display method provided in the foregoing embodiments.

Technical features of the foregoing embodiments may be combined in various manners. To make description concise, not all possible combinations of the technical features in the foregoing embodiments are described. However, the combinations of the technical features shall be considered as falling within the scope recorded by this specification provided that no conflict exists.

The foregoing embodiments only show several implementations of this application and are described in detail, but they are not to be construed as a limit to the patent scope of this application. A person of ordinary skill in the art may make various changes and improvements without departing from the ideas of this application, which shall all fall within the protection scope of this application. Therefore, the protection scope of the patent of this application shall be subject to the appended claims.

What is claimed is:

1. A recommended content display method that is performed by a terminal, the method comprising:
playing a target video in a video play region of a video player;
reducing a size of the video play region when the target video is played to closing credits; and
displaying, in the video player, the video play region with the reduced size and recommended content, where the video play region with the reduced size is used for continuing to play the target video.

2. The method according to claim 1, wherein before reducing the size of the video play region when the target video is played to closing credits, the method further comprises:
detecting whether the target video satisfies a recommendation condition; and
performing the operation of reducing the size of the video play region when the target video is played to closing credits and the target video satisfies the recommendation condition.

3. The method according to claim 2, wherein the detecting whether the target video satisfies the recommendation condition further comprises:
determining a target video set to which the target video belongs;
detecting whether the target video set includes a continuously played video corresponding to the target video, where a play sequence number of the continuously played video in the target video is set after that of the target video; and
determining that the target video satisfies the recommendation condition when the target video set does not include the continuously played video or when the target video set includes the continuously played video, but a video client does not have a play permission of the continuously played video.

4. The method according to claim 1, wherein the reducing the size of the video play region when the target video is played to closing credits further comprises:
obtaining a closing credit time point of the target video, the closing credit time point being a start time point of playing the closing credits; and
reducing the size of the video play region when the target video is played to the closing credit time point.

5. The method according to claim 1, wherein the reducing a size of the video play region when the target video is played to closing credits further comprises:
obtaining a total video duration of the target video;
determining a predicted closing credit time point according to the total video duration; and
reducing the size of the video play region when the target video is played to the predicted closing credit time point.

6. The method according to claim 1, wherein the reducing the size of the video play region when the target video is played to closing credits further comprises:
reducing the size of the video play region when a video picture satisfies a closing credit feature, the closing credit feature including at least one of a closing credit subtitle feature or a closing credit picture feature.

7. The method according to claim 1, wherein before reducing the size of the video play region when the target video is played to closing credits, the method further comprises:
obtaining a size of the video player; and
performing the operation of reducing the size of the video play region when the target video is played to closing credits and the size of the video player is greater than a size threshold.

8. The method according to claim 1, wherein:
the video play region whose size is reduced includes a restoring control, and
after the displaying, in the video player, the video play region with the reduced size and recommended content, the method further includes enlarging the video play region in response to receiving an operation signal for the restoring control.

9. The method according to claim 8, wherein:
the enlarged video play region includes a switching control, and
after the enlarging the video play region in response to receiving the operation signal for the restoring control, the method further includes reducing, in response to receiving an operation signal for the switching control, the size of the video play region, and displaying, in the video player, the video play region with the reduced size and the recommended content.

10. The method according to claim 1, wherein the video player includes the video play region, a first recommendation region, and a second recommendation region, an initial state of the video play region being a shown state, and initial states of the first recommendation region and the second recommendation region being hidden states, and
the displaying, in the video player, the video play region with the reduced size and recommended content further comprises:
displaying the video play region with the reduced size in a preset location of the video player;
setting the first recommendation region to be in the shown state, and displaying first recommended content in the first recommendation region, the first recommended content including a video associated with the target video; and
setting the second recommendation region to be in the shown state, and displaying second recommended content in the second recommendation region, the second recommended content including a ranking video and a recommended video, the ranking video and the target video belonging to a same video type, and the recommended video being determined according to a historical play record of a video client.

11. The method according to claim 10, wherein after the displaying, in the video player, the video play region with the reduced size and recommended content, the method further comprises:
playing the first recommended content through the video play region with the reduced size when the target video is completely played, and updating the first recommended content displayed in the first recommendation region; and
enlarging the video play region in response to receiving a selection signal for the first recommended content or the second recommended content, and playing a selected first recommended content or second recommended content through the enlarged video play region.

12. A recommended content display apparatus, comprising processing circuitry configured to cause the recommended content display apparatus to implement the recommended content display method according to claim 1.

13. A terminal, comprising a processor and a memory that stores at least one instruction that, when executed by the processor, causes the processor to perform:
playing a target video in a video play region of a video player;
reducing a size of the video play region when the target video is played to closing credits; and
displaying, in the video player, the video play region with the reduced size and recommended content, the video play region with the reduced size being used for continuing to play the target video.

14. The terminal according to claim 13, wherein the processor to further performs:
detecting whether the target video satisfies a recommendation condition; and
performing the operation of reducing the size of the video play region when the target video is played to closing credits and the target video satisfies the recommendation condition.

15. The terminal according to claim 14, wherein the processor performs the operation of detecting whether the target video satisfies the recommendation condition by:
determining a target video set to which the target video belongs;
detecting whether the target video set includes a continuously played video corresponding to the target video, where a play sequence number of the continuously played video in the target video is set after that of the target video; and
determining, when the target video set does not include the continuously played video or in a case that the target video set includes the continuously played video, but a video client does not have a play permission of the continuously played video, that the target video satisfies the recommendation condition.

16. The terminal according to claim 13, wherein the processor performs the operation of reducing the size of the video play region when the target video is played to closing credits by:
obtaining a closing credit time point of the target video, the closing credit time point being a start time point of playing the closing credits; and
reducing the size of the video play region when the target video is played to the closing credit time point.

17. A non-transitory computer-readable storage medium storing at least one instruction that, when executed by a processor, causes the processor to perform:
playing a target video in a video play region of a video player;
reducing a size of the video play region when the target video is played to closing credits; and
displaying, in the video player, the video play region with the reduced size and recommended content, the video play region with the reduced size being used for continuing to play the target video.

18. The non-transitory computer-readable storage medium according to claim 17, wherein the processor further performs:
detecting whether the target video satisfies a recommendation condition; and
performing the operation of reducing the size of the video play region when the target video is played to closing credits and the target video satisfies the recommendation condition.

19. The computer-readable storage medium according to claim 18, wherein the processor performs the operation of detecting whether the target video satisfies the recommendation condition by:
determining a target video set to which the target video belongs;
detecting whether the target video set includes a continuously played video corresponding to the target video, where a play sequence number of the continuously played video in the target video is set after that of the target video; and
determining, in a case that the target video set does not include the continuously played video or in a case that the target video set include the continuously played video, but a video client does not have a play permission of the continuously played video, that the target video satisfies the recommendation condition.

20. The non-transitory computer-readable storage medium according to claim 17, wherein the processor performs the operation of reducing the size of the video play region when the target video is played to closing credits by:
obtaining a closing credit time point of the target video, the closing credit time point being a start time point of playing the closing credits; and
reducing the size of the video play region when the target video is played to the closing credit time point.
